(19) United States
(12) Patent Application Publication
(10) Pub. No.: US 2008/0044707 A1
(43) Pub. Date: Feb. 21, 2008

(54) FLEXIBLE FUEL CELL

(75) Inventors: Justin C.P. CHOU, Hsinchu City (TW); Chien-Fu Kuo, Taichung City (TW); Po-Han Huang, Taipei City (TW); Ming-Hsuan Chien, Hsinchu City (TW); Shih-Tsung Ke, Siaying Township (TW); Tsong-Pyng Perng, Hsinchu (TW)

Correspondence Address: EGBERT LAW OFFICES, 412 MAIN STREET, 7TH FLOOR, HOUSTON, TX, 77002, US

(73) Assignee: NATIONAL TSING HUA UNIVERSITY, Hsinchu (TW)

(21) Appl. No.: 11/466,067

(22) Filed: Aug. 21, 2006

(51) Int. Cl. H01M 8/24; H01M 2/08; H01M 8/10

(52) U.S. Cl. 429/32; 429/127; 429/35; 429/38

(57) ABSTRACT

The present invention is a flexible fuel cell, which overcomes the shortcomings of a conventional fuel cell made of solid materials. The flexible fuel cell includes a battery pack of fuel cell units with a preset amount and configuration of fuel cell units, and a flexible locator. The flexible locator is made of flexible materials to ensure the ability to maintain gas-tight seals. Because of the ability to maintain good gas-tight seals and to have stronger resistance to heat and corrosion, the fuel cell of the present invention offers advantages of light weight, gas-tight sealing, and shock resistance.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a fuel cell, and more particularly to a flexible fuel cell that maintains air-tight seals, that is light-weight, and that has strong shock resistance.

### BACKGROUND OF THE INVENTION

Energy independence has been an important economic consideration of countries worldwide for a long time. In recent years, the increase in oil price has raised a serious concern with respect to alternative energy and has also driven countries to actively develop alternative energy technologies. The founder of Ballard Power Systems, Dr. Geoffrey Ballard in 2002 stressed that: “We must guarantee [a] sufficient and sustainable energy supply in order to develop and improve the level of medicine, science, education and social responsibility as well as standard of living.” Therefore, an alternative energy source is a necessity in view of the declining oil supply.

Today, wind energy, solar energy and nuclear energy are well-known alternative energy sources. For instance, many member countries of the EU have developed wind and solar power facilities. Specifically, the electricity from wind energy is less than 1% of worldwide power consumption, but accounts for 20% of power consumption in Denmark. New wind power generators are installed in the EU every year, e.g. 570 GW power generator units in 2004. However, wind energy and solar energy are vulnerable to weather conditions and are restricted in terms of being used as a power supply. In another example, the government of Iceland is committed to developing hydrogen energy by virtue of abundant hydraulic power and terrestrial heat, in combination with fuel cells.

As a power generating system, a fuel cell converts chemical energy into electrical energy using an oxidation-reduction reaction of hydrogen and oxygen. Since this progress does not yield any CO₂, many fuel cell systems were developed by some developed countries long time ago, such as solid oxygen fuel cell, referred to as “SOFC”, for large-scale power generating systems, and proton exchange membrane fuel cell, referred to as “PEMFC” for small stationary power generating systems in lieu of vehicle engines, and direct methanol fuel cell, referred to as “DMFC” for 3C electronic power supply modules. Moreover, the hydrogen required for a fuel cell contributes to reduce oil consumption while minimizing emission of CO₂.

It is further understood that a portable fuel cell, as a small power generating system, is able to energize 3C electronics continuously and reliably, at anytime and anywhere.

A portable room-temperature PEMFC plays a big part in fuel cells because of developed technology in the art. Complex designs are required if applied to high-power stationary power generating systems. As compared to DMFC, portable PEMFC has more opportunities for commercial applications owing to its lower required catalyst loading, which accounts a large portion of the cost. Room-temperature PEMFC has lower power output than that of stationary high-temperature PEMFC system; therefore the heat and water management is much simple. The advantage of fuel cell is that the output voltage can be increased by adding many single cells in series, thus providing reliable DC at a required voltage. In contrast to the traditional fuel cell stack model, cell modules can be horizontally connected in series. This horizontal model often provides oxygen to the cell using the method of diffused respiration, thereby minimizing the volume of a fan in the fuel cell. So, it is optimally suited for a portable fuel cell. In 2003, a paper published by A. Schmitz et al, indicated a successful development of a fuel cell with PCB as a polar plate of flow field and 100 mW/cm2 current was achieved at 500 mV, of which the supply of oxygen is realized by diffused respiration.

A conventional portable fuel cell is often made of and covered by metallic materials and has a flow field shaped to connect fuel cells. This configuration of fuel cells has some disadvantages. First, the prior art fuel cell is not light-weight. Since being light-weight is an important objective for portable products, the metallic materials used in a conventional fuel cell cannot meet the application requirements for not being light-weight enough to be portable. Second, the prior art fuel cell does not maintain gas-tight seals. A fuel cell with an internal flow field is formed by combining upper and lower templates. Therefore, the butt joint of these solid materials generates a gap, thus possibly leading to gas leakage. Third, the prior art fuel cell has poor shock resistance. A portable fuel cell offers a greater possibility of collision, shock and drop. Due to lack of shock resistance, the solid materials of the prior art are not helpful towards maintaining the installation accuracy of the cell structure and gas-tight seals in the flow field. Thus, the life span of the portable fuel cell is shortened.

Another problem is that the polar plate and flow field account for a higher percentage of the volume, weight and cost of the fuel cell. In spite of good conductivity, a traditional polar plate made of graphite has the disadvantage of being heavy. Similarly, the flow field of the prior art is also heavy and accounts for a greater percentage of overall weight.

Thus, to overcome the aforementioned problems of the prior art, it would be an advancement in the art to provide an improved fuel cell that features a higher degree of flexibility and applicability.

To this end, the inventor has provided the present invention of practicability after deliberate design and evaluation based on his years of experience in the production, development and design of related products.

### BRIEF SUMMARY OF THE INVENTION

The flexible fuel cell of the present invention offers an innovative and unique fuel cell structure with a flexible locator. Flexible materials of the present invention have the characteristics of maintaining gas-tight seals and having strong resistance to heat and corrosion. The fuel cell of the present invention is light-weight, maintains gas-tight seals, and has flexibility as well as strong shock resistance, making it possible to meet the demanding requirements in a mobile environment.

Another feature of the present invention is that each fuel cell unit is made of plastic polar plates. Each polar plate is also provided with a conductive metallic layer. As such, the fuel cell of the present invention is light-weight, reduces heat loss and has good conductivity as compared with a conventional fuel cell of the prior art.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a perspective view of the application of the flexible fuel cell on a portable power supply device.

FIG. 2 shows an exploded perspective view of the flexible fuel cell of the present invention.

FIG. 3 shows a partial perspective view of the flexible fuel cell of the present invention.

FIG. 4 shows a sectional view of the flexible fuel cell of the present invention.

FIG. 5 shows another sectional view of the flexible fuel cell of the present invention.

FIG. 6 shows an exploded perspective view of the fuel cell unit of the present invention.

FIG. 7 shows an exploded sectional view of the fuel cell unit of the present invention.

### DETAILED DESCRIPTION OF THE INVENTION

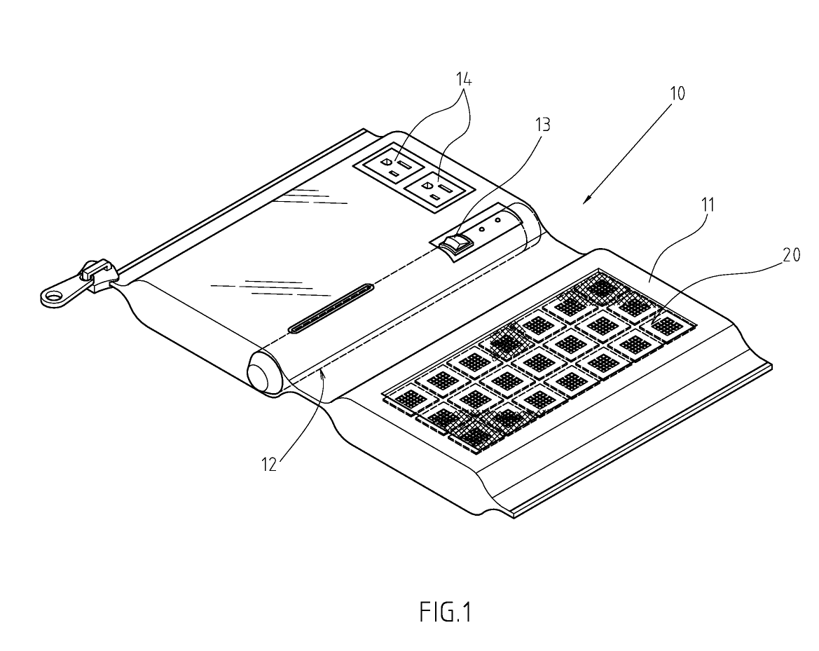

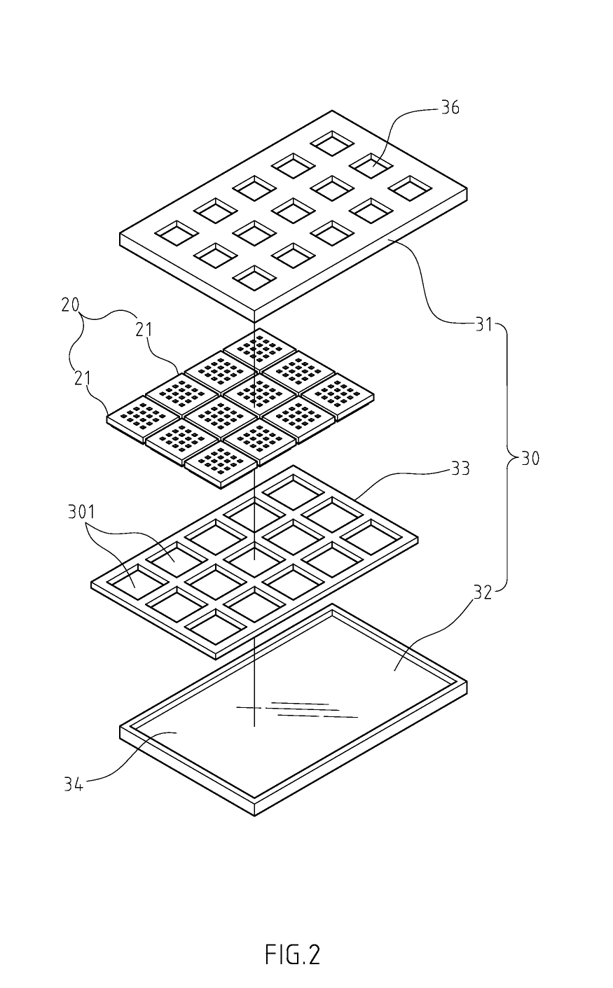

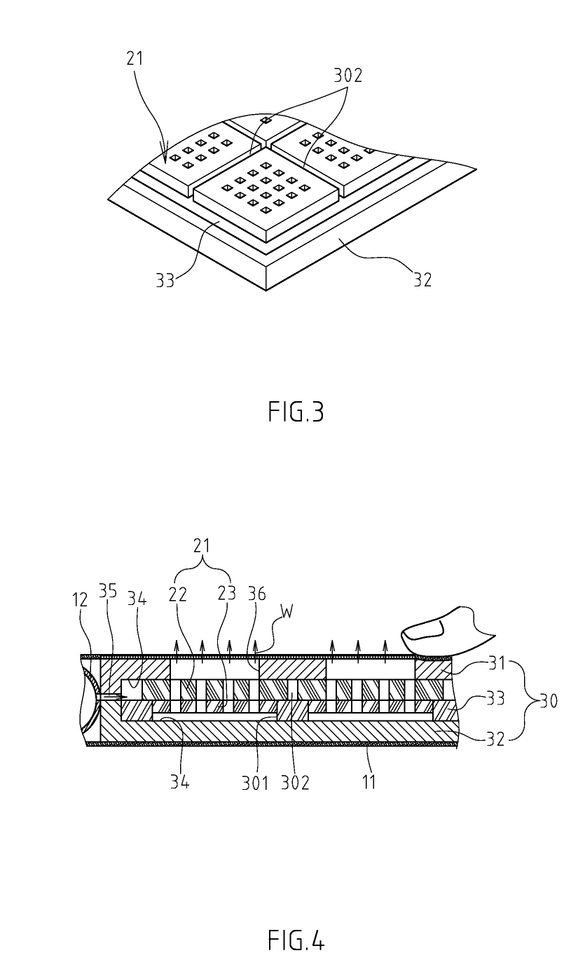

Referring to FIGS. 1, 2, 3, and 4, the preferred embodiments of the present invention are presented. These figures are provided only for explanatory purposes because the scope of the invention is set by the claims. The flexible fuel cell of the present invention is integrated with a portable power supply device.

A portable power supply device 10 is comprised of a sealed surface layer 11, a fuel supplier 12, a control switch 13 and a power transmission unit 14. The sealed surface layer 11 is made of water-proof non-woven fabric, which ensures user-friendly operation. The fuel supplier 12 can be a metal hydride tank. The power transmission unit 14 is either an AC or DC socket for charging of 3C electronics (e.g. mobile phones, PDAs, PCs and digital cameras, etc).

A battery pack 20 is formed by a specific amount and configuration of fuel cell units 21, wherein fifteen 4 cm² batteries are connected in series to achieve a 5V voltage output. Average operating voltage of a battery is about 0.3V-0.4V, having a constant current of 4 A, and achieving 20 W output power. Each fuel cell unit 21 comprises polar plates 22 and, 23 and a membrane electrode assembly (MEA) 24, of which the polar plate is provided with a flow field 25 and electrode 26, and the MEA 24 contains a proton exchange membrane, catalyst and diffusion layer.

A flexible locator 30 is used to cover and position each fuel cell unit 21. The flexible locator 30 is made of flexible materials, thus presenting satisfactory characteristics, such as flexibility and elasticity (as illustrated in FIG. 4). In practice, the flexible materials are a good choice because of outstanding ability to maintain gas-tight seals and to have strong resistance to heat and corrosion. The flexible locator 30 is internally provided with chambers 301 for creating gas flow field 302 between fuel cell units 21. The flexible locator 30 of the present invention comprises a top base 31, a bottom base 32, and a central base 33. The top and bottom bases 31 and, 32 form an enclosed and recessed space 34. The central base 33 is placed into the recessed space 34, such that chamber 301 are formed therein to accommodate fuel cell units 21. The gas flow field 302 is shaped from a gap between each fuel cell unit 21 and the spacing between fuel cell units 21 and the central base 33. A hydrogen inlet 35 is mounted onto one side of top base 31 and connected to fuel supplier 12, such that hydrogen is guided into the gas flow field 302 of the recessed space 34. Based upon the design of flexible locator 30, the present invention allows proper bending (as shown by arrow L in FIG. 5), but has no influence upon normal operation of fuel cell unit 21 and gas-tight seals of the flow fields 302.

The damp diffusion holes 36 are mounted onto flexible locator 30 opposite to fuel cell units 21, such that residual moisture is removed through the reaction of oxygen and hydrogen (as shown by arrow W in FIG. 4).

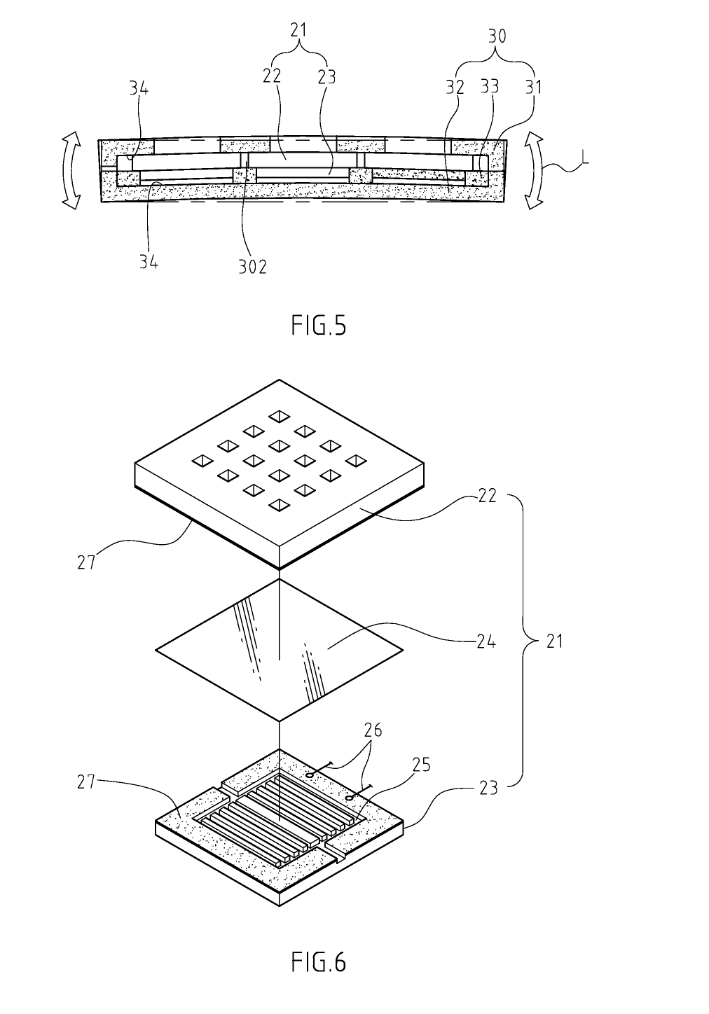

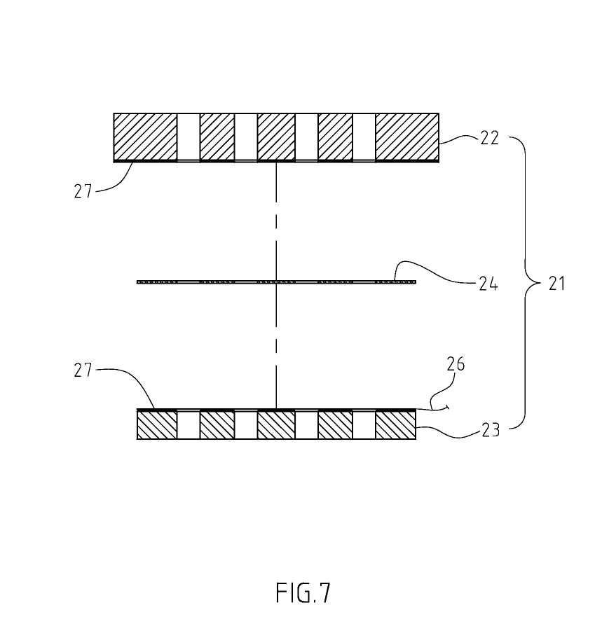

Referring to FIGS. 6, and 7, the polar plates 22 and, 23 of each fuel cell unit 21 is made of plastic (e.g. ABS), and a conductive layer 27 (e.g. nickel plating) is electroless plated onto the surface of each polar plate with a plastic flow field 25. In this case, no deformation will occur at room temperature, and heat emission is slower than metal, thus reducing the weight and heat loss. Meanwhile, each polar plate has good conductivity since the electroless plated plastic flow field 25 has a better conductivity than graphite.

We claim:

1. A flexible fuel cell structure comprising:
a battery pack composed of a plurality of fuel cell units, said battery pack having a preset amount of fuel cell units and configuration, each fuel cell unit being composed of a polar plate and membrane electrode assembly, said polar plate having a flow field and electrode;
a flexible locator covering and positioning each fuel cell unit of said battery pack, said flexible locator being composed of flexible materials and being internally provided with a chamber and gas flow field; and
a sealed surface layer mounted externally onto said flexible locator.

2. The structure defined in claim 1, further comprising:
a plurality of damp diffusion holes mounted onto said flexible locator opposite to each fuel cell unit of said battery pack.

3. The structure defined in claim 1, wherein said polar plate of each fuel cell unit is composed of plastic materials, said polar plate having a conductive metallic layer electroless plated onto a surface thereof.

4. The structure defined in claim 1, wherein said flexible locator comprises a top base, a bottom base and a central base, said top base and said bottom base forming a recessed space, said central base being placed into said recessed space and forming chambers in said flexible locator, said plurality of fuel cell units being accommodated in said chambers, said top base having a hydrogen inlet mounted on one side thereof, said hydrogen inlet being connected to a fuel supplier, said recessed space having hydrogen guided thereinto from said hydrogen inlet.

5. A portable power supply device with a flexible fuel cell, the device comprising:
a fuel source having a sealed surface layer, a fuel supplier, a control switch and a power transmission unit; and
a battery pack composed of plurality of fuel cell units, said battery pack having a preset amount of fuel cell units and configuration of fuel cell units, each fuel cell unit being composed of a polar plate and membrane electrode assembly, said polar plate having a flow field and electrode; and
a flexible locator covering and positioning each fuel cell unit, said flexible locator being composed of flexible materials and being internally provided with a chamber and gas flow field.

6. The structure defined in claim 5, further comprising:
a plurality of damp diffusion holes mounted onto said flexible locator opposite to each fuel cell unit of said battery pack.

7. The structure defined in claim 5, wherein said polar plate of each fuel cell unit is composed of plastic materials, said polar plate having a conductive metallic layer electroless plated onto a surface thereof.

8. The structure defined in claim 5, wherein said flexible locator comprises a top base, a bottom base and a central base, said top base and said bottom base forming a recessed space, said central base being placed into said recessed space and forming chambers in said flexible locator, said plurality of fuel cell units being accommodated in said chambers, said top base having a hydrogen inlet mounted on one side thereof, said hydrogen inlet being connected to a fuel supplier, said recessed space having hydrogen guided thereinto from said hydrogen inlet.
